(19) United States
(12) Patent Application Publication
(10) Pub. No.: US 2021/0239255 A1
(43) Pub. Date: Aug. 5, 2021

(54) Heated Hose For Delivering A Liquid Adhesive

(71) Applicant: Robatech AG, Muri (CH)

(72) Inventors: Stephan Knecht, Oberwil-Lieli (CH); Micha Schären, Muri (CH); Markus Sennrich, Rombach (CH)

(73) Assignee: Robatech AG, Muri (CH)

(21) Appl. No.: 17/162,048

(22) Filed: Jan. 29, 2021

(30) Foreign Application Priority Data
Jan. 30, 2020 (EP) 20 154 567.0

(51) Int. Cl. F16L 59/02; F16L 53/34; B05C 11/10

(52) U.S. Cl. CPC F16L 59/027; B05C 11/1042; F16L 53/34

(57) ABSTRACT

A heated hose for delivering a liquid, in particular for delivering an adhesive has a flexible hose for the passage of the liquid, an insulating layer surrounding the flexible hose, and a heating device surrounding the flexible hose. The heating device is arranged between the flexible hose and the insulating layer. The insulating layer has a strip-shaped insulating material that is wound helically around the flexible hose. The strip-shaped insulating material contains an aerogel.

### FIELD OF THE INVENTION

The invention relates to a heated hose for delivering a liquid, in particular for delivering an adhesive. The adhesive is preferably a hot melt adhesive. The heated hose according to the invention is used, in particular, to convey or deliver liquid hot melt adhesive or other substances that are fluid in the hot state from a melting device to an application head. The heated hose is used, in particular, for attachment to a melting device, wherein the melting device is used to melt the hot melt adhesive, which is solid at room temperature. Using the heated hose, the hot melt adhesive is then delivered to the application point, typically an application head, wherein the adhesive is applied to a substrate at the application point or by means of the application head. In particular, the heated hose is used to keep the liquid to be delivered in the heated hose within a certain temperature range and/or to heat the liquid to be delivered to a particular target temperature or to a particular target temperature range in the heated hose.

### BACKGROUND OF THE INVENTION AND RELATED ART

A heated hose is known from US 2003/0007789 A1. The heated hose known from the abovementioned document has:
a flexible hose for the passage of the liquid,
an insulating layer surrounding the flexible hose, and
a heating device surrounding the flexible hose, wherein the heating device is arranged between the flexible hose and the insulating layer. The insulating layer has a strip-shaped insulating material, wherein the strip-shaped insulating material is wound helically around the flexible hose.

### OBJECT OF THE INVENTION

It is the object of the present invention to achieve particularly low heat loss from the heated hose with a radial extent and thus a thickness of the heated hose which is as small as possible.

This object is achieved by a heated hose which has the features described and shown herein.

### SUMMARY OF THE INVENTION

According to the invention, it is envisaged that the strip-shaped insulating material contains an aerogel. As used herein, the term “aerogel” is intended to refer generally to a synthetic, porous, ultralight material derived from a gel, in which the liquid component for the gel has been replaced with a gas without significant collapse of the gel structure. The result is a solid with extremely low density and extremely low thermal conductivity.

Aerogels are highly porous solids that have a multiplicity of pores. Aerogels are distinguished by particularly low thermal conductivity.

Owing to the particularly low thermal conductivity of the aerogel, the strip-shaped insulating material likewise has a particularly low thermal conductivity, and therefore the strip-shaped insulating material can have a relatively small thickness and particularly good thermal insulation of the flexible hose can nevertheless be achieved.

Aerogels, or materials containing conventional aerogels, have the characteristic that they are easily damaged by mechanical stress and tend to form dust under mechanical stress. On the one hand, this damage has a disadvantageous effect on the insulating action. On the other hand, there is the risk that abraded material and/or dust will enter the environment, possibly resulting in unwanted contamination of the liquid to be processed and/or of the substrates to which the liquid is to be applied, for example. It is furthermore advantageous to avoid the formation of dust in the production of the heated hose in order to eliminate otherwise necessary protective measures, e.g. extraction systems, masks etc.

The use of a strip-shaped insulating material which contains aerogel and is wound helically around the flexible hose has proven advantageous since, when there is mechanical stress on the heated hose, e.g. in the form of bending of the heated hose, displacement of the windings relative to one another is possible, thus reducing the local tensile and compressive stress on the insulating material of the insulating layer. Abrasion of and/or dust formation by the aerogel contained in the insulating material is thereby avoided or at least reduced.

In the present context, the term “helically” is not necessarily understood to mean winding with a constant lead angle. However, winding with a constant lead angle is regarded as particularly advantageous.

With regard to thermal insulation which is particularly good and as constant as possible over the length of the hose, it has proven advantageous if the strip-shaped insulating material is wound in a self-overlapping manner around the flexible hose. The overlap is preferably about 20% to about 50%, more preferably about 40% to about 50%, and in particular about 45% to about 50%, in relation to the width of the strip-shaped insulating material. An overlap of about 50% is regarded as particularly advantageous. In the case of an overlap of about 50%, the thickness of the insulating layer is approximately twice the thickness of the strip-shaped insulating material. In the event of a bending movement of the heated hose, the winding has the effect that the insulating material is stretched and compressed to a lesser extent, especially in comparison with insulating materials in tubular form, and furthermore the wound layers can slide under one another somewhat, ensuring that, even in the case of a heated hose that has been laid in a bent shape, gaps in the insulating layer are avoided in the region of the bend.

As regards a particularly high mechanical stability of the insulating material and particularly simple and rapid processing of the insulating material to form the insulating layer, it has proven advantageous if the strip-shaped insulating material has a width of about 15 mm to about 60 mm.

The strip-shaped insulating material preferably has a thickness of about 0.5 mm to about 6.0 mm, in particular a thickness of about 2 mm to about 5 mm, and preferably a thickness of about 1 mm to about 3 mm.

A ratio of the thickness of the insulating material to the width of the insulating material is preferably between about 1/30 and about ⅙.

The aerogel is, in particular, an aerogel based on silicate, e.g. silica aerogel.

The insulating material is in particular nonwoven.

In order to achieve particularly good mechanical stability of the insulating material, it is regarded as advantageous if the insulating material has a supporting structure. This supporting structure is, in particular, a fiber-based supporting structure. In particular, the supporting structure can contain polyester fibers and/or glass fibers.

To avoid or at least reduce damage to the insulating material and/or release of dust during the processing or mechanical loading of the insulating material, e.g. when the heated hose is bent, it is regarded as particularly advantageous if the insulating material has a coating, preferably a dustproof or dust-retaining coating. In order to achieve particularly good sliding properties for the windings, e.g. when the heated hose is bent, it is regarded as advantageous if the coating is a friction-reducing coating.

The coating is, in particular, a coating based on silicone and/or polyurethane. In particular, the coating is a silicone coating or a polyurethane coating.

It is furthermore entirely conceivable to provide a sheath for the strip-shaped insulating material in addition or as an alternative to the coating. The sheath can be a sheath consisting of a plastic film, for example. Paper-type materials are also conceivable for the sheath, in particular coated paper-type materials, e.g. in the form of nonstick baking paper. The sheath preferably surrounds the insulating material without adhering to it.

In a particularly advantageous embodiment, it is envisaged that the heated hose has a, preferably dustproof, covering layer, wherein the covering layer directly surrounds the insulating layer. Such a configuration is to be regarded as advantageous, particularly in respect of the avoidance of the formation of dust due to mechanical loading of the insulating material during the production of the heated hose. Moreover, the covering layer is regarded as particularly advantageous inasmuch as further layers of the heated hose that surround the insulating layer do not make direct contact with the insulating layer, thereby avoiding damage to the insulating material or insulating layer.

The covering layer is, in particular, a strip-shaped covering material, wherein the strip-shaped covering material is wound helically around the insulating layer, preferably being wound in a self-overlapping manner around the insulating layer. The strip-shaped covering material can be, in particular, a textile tape or a woven glass fiber tape. The strip-shaped covering material can be, in particular, a covering material having an adhesive layer. The adhesive layer is preferably configured in such a way that it does not adhere to the insulating material, and therefore there is only self-adhesion of the covering material in the region of the self-overlap.

In a particularly preferred embodiment of the heated hose, the heated hose has a control line and/or an electric supply line, wherein the control line and/or the electric supply line can be connected to a delivery device component and/or application device component that interacts with the heated hose. Integrating the electric supply line and/or the control line into the heated hose has the advantage that the lines do not have to be routed separately to the components interacting with the heated hose. As a result, installation is simple and clear and has a low susceptibility to error. In the case of manual uses, the safety of personnel is enhanced since the number of connecting lines in an embodiment of this kind can be kept particularly small.

In the context of an integrated control line and/or electric supply line, it is regarded as particularly advantageous if the heated hose has a connecting structure, wherein the connecting structure is connected to the control line and/or to the electric supply line, and the connecting structure can be connected to a corresponding mating structure of the component. This makes the handling, in particular the installation, of the heated hose possible in a particularly simple matter. In particular, the connecting structure is designed as a plug, and the mating structure as a socket or vice versa.

As regards the control line and/or the electric supply line, it is regarded as particularly advantageous if these are wound helically around the insulating layer, in particular the control line and/or the electric supply line being wound helically around the covering layer.

In a particularly preferred embodiment, the heated hose has a, preferably continuous, outer cover. The outer cover is, in particular, an outer sheath composed of silicone, polyurethane or polyethylene. The outer cover is preferably configured in such a way that penetration of water into the interior of the heated hose is avoided. In respect of cleaning of the outer cover of the heated hose, it is regarded as particularly advantageous if the outer cover is of smooth design. This makes cleaning or washing of the outer cover particularly easy. It is furthermore regarded as particularly advantageous if the outer cover is composed of an electrically insulating material or is an electrical insulator.

The outer cover is preferably an extruded silicone hose or a foamed silicone hose.

The outer cover is preferably slid onto the other component parts of the heated hose.

In order to improve particularly good sliding of the outer cover over the other component parts of the heated hose when sliding the outer cover on and/or when bending the heated hose, it is regarded as particularly advantageous if an inner side of the outer cover is designed in such a way that it has a particularly low coefficient of friction. This can be achieved by coating the inner side of the outer cover with talcum powder, for example.

It is furthermore regarded as particularly advantageous if an inside diameter of the outer cover is slightly larger than the outside diameter of a heated hose layer adjacent to the outer cover.

It is regarded as particularly advantageous if a winding direction of the covering material and/or a winding direction of the control line and/or a winding direction of the electric supply line and/or a winding direction of the heating device correspond/corresponds to a winding direction of the insulating material. All of the component parts of the heated hose which are wound helically around the flexible hose preferably have the same winding direction. A configuration of this kind has proven advantageous in respect of good flexibility of the heated hose combined with particularly low mechanical loading of the individual component parts.

In an advantageous development of the heated hose, it is envisaged that a lead angle of the windings of the strip-shaped insulating material is between about 5° and about 30°, in particular between about 10° and about 15°.

The flexible hose is, in particular, a high-pressure hose.

The flexible hose preferably has an inner core of PTFE. However, it is also entirely conceivable for the inner core to be composed of some other fluorinated plastic.

The flexible hose preferably has external armoring consisting of a braided metal mesh, in particular armoring composed of braided steel wires. As regards the armoring, it is entirely conceivable that a braided mesh consisting of aramid fibers could be used instead of braided steel wires or braided metal wires.

In a preferred embodiment, an inner core of the flexible hose is formed by a corrugated metal hose. The corrugated metal hose can have parallel corrugations or spiral corrugations. It is furthermore entirely conceivable, once again, for the inner core in the form of a corrugated metal hose to be surrounded by external armoring, in particular armoring of the abovementioned type.

The heating device is, in particular, a resistance heating device having at least one heating wire.

It is entirely conceivable that the heated hose additionally comprises a temperature sensor, wherein the temperature sensor is preferably arranged between the insulating layer and the flexible hose.

The heated hose is preferably designed to keep or heat the liquid to be delivered within or to a temperature range of about 80° C. to about 230° C., in particular about 120° C. to about 200° C.

The invention is described in greater detail in the accompanying drawing figures by means of an exemplary embodiment without being restricted thereto.

### BRIEF DESCRIPTION OF THE DRAWING FIGURES

FIG. 1 shows an exemplary embodiment of a heated hose according to the present invention in a sectional view.

FIG. 2 shows the heated hose according to FIG. 1 in an intermediate stage during the production of the heated hose, in a perspective view.

### DESCRIPTION OF EXEMPLARY EMBODIMENTS

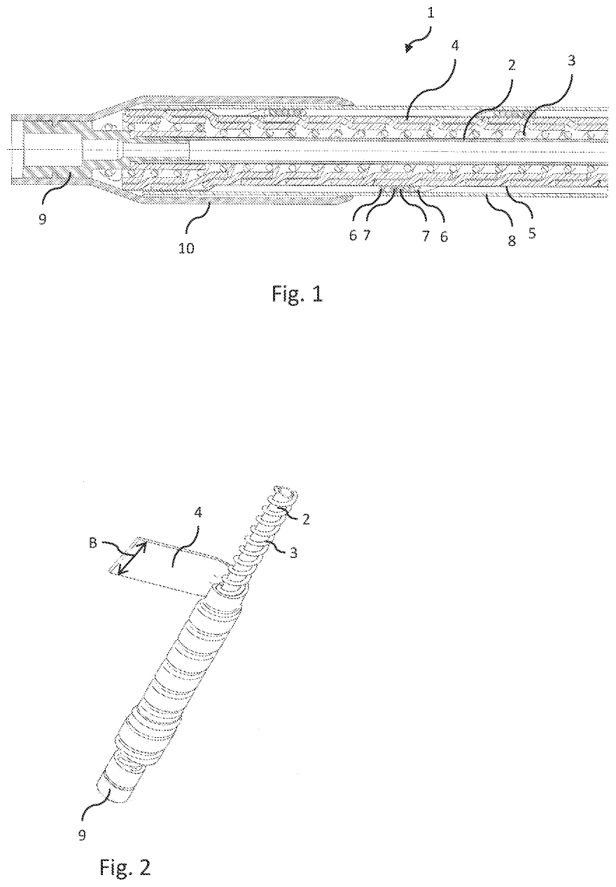

FIGS. 1 and 2 show a heated hose 1 for delivering a liquid, in the present case for delivering an adhesive, wherein FIG. 2 shows the heated hose 1 in an intermediate stage during the production of the heated hose 1, and FIG. 2 thus shows the heated hose 1 in an unfinished state.

The heated hose 1 has a flexible hose 2 for the passage of the liquid. The flexible hose 2 is surrounded by a heating device 3, wherein, in the present case, the heating device 3 comprises two heating wires wound helically around the flexible hose 2, wherein one end of one heating wire is connected to one end of the other heating wire. With such a configuration of the heating device 3 with heating wires connected to one another at the ends, it is possible to connect the power supply of the heating device 3 at just one end of the heated hose 1. It is regarded as particularly advantageous if the respective heating wire is surrounded by electric insulation. The electric insulation can be, for example, a PTFE coating or silicone coating, or a casing made of PTFE or a casing made of silicone. The material PTFE is preferred, however.

The heated hose 1 furthermore has an insulating layer surrounding the flexible hose 2 and the heating device 3, wherein the insulating layer is formed by a strip-shaped insulating material 4, wherein the strip-shaped insulating material 4 is wound helically and in a self-overlapping manner around the flexible hose 2 and the heating device 3, wherein the overlap is about 50% in relation to a width B of the strip-shaped insulating material 4. The strip-shaped insulating material 4 has an aerogel.

The heated hose 1 furthermore has a covering layer 5 which is dustproof or at least reduces the release of dust, wherein the covering layer 5 directly surrounds the insulating layer. The heated hose 1 furthermore comprises a plurality of control lines 6 and a plurality of electric supply lines 7, wherein the plurality of control lines 6 and the plurality of electric supply lines 7 are wound helically around the covering layer 5.

The heated hose 1 has an outer cover 8, wherein the outer cover 8 surrounds the control lines 6 and the electric supply lines 7 and seals off the internal component parts of the heated hose 1 from the environment.

At the end, the heated hose 1 has a connecting structure 9 in order to establish fluid communication between the heated hose 1 and further components of an application device and/or delivery device and/or melting device. In order to prevent penetration of dust and/or liquids into the interior of the heated hose 1 in the region of the connecting structure 9, the heated hose 1 has at the end, and thus in the region of the connecting structure 9, an end cap 10 which surrounds the connecting structure 9, wherein the end cap 10 also surrounds a partial region at the end of the outer cover 8.

It is entirely conceivable that the heated hose 1 additionally comprises a temperature sensor, wherein the temperature sensor is preferably arranged between the insulating layer and the flexible hose 2.

As can be seen especially from FIG. 1, all of the component parts of the heated hose 1 which are wound helically around the flexible hose 2 have the same winding direction.

That which is claimed is:

1. A heated hose for delivering a liquid, comprising:
a flexible hose for the passage of the liquid;
an insulating layer surrounding the flexible hose; and
a heating device surrounding the flexible hose;
wherein the heating device is arranged between the flexible hose and the insulating layer;
wherein the insulating layer comprises a strip-shaped insulating material;
wherein the strip-shaped insulating material is wound helically around the flexible hose; and
wherein the strip-shaped insulating material contains an aerogel.

2. The heated hose as claimed in claim 1, wherein the strip-shaped insulating material has a width of about 15 mm to about 60 mm and/or the strip-shaped insulating material has a thickness of about 1 mm to about 3 mm.

3. The heated hose as claimed in claim 1, wherein the strip-shaped insulating material is wound in a self-overlapping manner around the flexible hose, the overlap being about 20% to about 50% in relation to the width of the strip-shaped insulating material.

4. The heated hose as claimed in claim 1, wherein the aerogel is an aerogel based on silicate.

5. The heated hose as claimed in claim 1, wherein the insulating material has a fiber-based supporting structure.

6. The heated hose as claimed in claim 1, wherein the strip-shaped insulating material has a coating.

7. The heated hose as claimed in claim 6, wherein the coating is a silicone based coating or a polyurethane based coating.

8. The heated hose as claimed in claim 1, wherein the strip-shaped insulating material has a sheath.

9. The heated hose as claimed in claim 1, wherein the heated hose has a covering layer that directly surrounds the insulating layer.

10. The heated hose as claimed in claim 9, wherein the covering layer comprises a strip-shaped covering material that is wound helically around the insulating layer in a self-overlapping manner around the insulating layer.

11. The heated hose as claimed in claim 1, wherein the heated hose comprises a control line and/or an electric supply line configured to be connected to a delivery device component and/or an application device component that interacts with the heated hose, the heated hose having a connecting structure that is connected to the control line and/or to the electric supply line, wherein the connecting structure is configured to be connected to a corresponding mating structure of the delivery device component and/or the application device component.

12. The heated hose as claimed in claim 11, wherein the control line and/or the electric supply line are/is wound helically around the insulating layer.

13. The heated hose as claimed in claim 1, wherein the heated hose has an outer cover.

14. The heated hose as claimed in claim 1, wherein a winding direction of the covering material and/or a winding direction of the control line and/or a winding direction of the electric supply line and/or a winding direction of the heating device correspond/corresponds to a winding direction of the insulating material.

15. The heated hose as claimed in claim 1, wherein a lead angle of the strip-shaped insulating material that is wound helically around the flexible hose is between about 5° and about 30°.

16. The heated hose as claimed in claim 15, wherein the lead angle of the strip-shaped insulating material that is wound helically around the flexible hose is about 15°.

17. The heated hose as claimed in claim 3, wherein the overlap is about 45% to about 50% in relation to the width of the strip-shaped insulating material.

18. The heated hose as claimed in claim 6, wherein the coating is a friction-reducing coating and/or a dust-retaining coating.

19. The heated hose as claimed in claim 11, wherein the control line and/or the electric supply line are/is wound helically around the covering layer.

20. The heated hose as claimed in claim 14, wherein all of the component parts of the heated hose which are wound helically around the flexible hose have the same winding direction.
